(19) United States
(12) Patent Application Publication
(10) Pub. No.: US 2008/0016253 A1
(43) Pub. Date: Jan. 17, 2008

(54) Graphical user interface for navigating and manipulating objects exposed by a host

(75) Inventor: Peter Boctor, Seattle, WA (US)

Correspondence Address: LAW OFFICES OF MICHAEL DRYJA, 1474 N COOPER RD #105-248, GILBERT, AZ, 85233, US

(73) Assignee: BOCTOR DESIGN, LLC, Seattle, WA (US)

(21) Appl. No.: 11/456,835

(22) Filed: Jul. 11, 2006

(51) Int. Cl. G06F 15/177; G06F 15/16

(52) U.S. Cl. 709/250; 709/220

(57) ABSTRACT

A graphical user interface (GUI) is provided for navigating and manipulating objects exposed by a host, such as a host computer program or a host computer system. Particularly, an interface of the host is accessed to receive a list of hierarchically organized objects that the host supports. Each object has one or more attributes supported thereby and/or one or more operations supported thereby. A GUI is provided by which a user is to navigate a plurality of the objects to select one or more desired objects, and a GUI is provided by which the user is to manipulate the attributes and/or the operations of the objects selected. The host is manipulated based at least on the objects selected as to which the attributes and/or the operations thereof have been manipulated.

### FIELD OF THE INVENTION

The present invention relates generally to software objects, such as that which may be exposed by an application programming interface (API) of a host computer program or computer system, and more particularly to a graphical user interface (GUI) for navigating and manipulating such objects.

### BACKGROUND OF THE INVENTION

Host computer programs and computer systems are commonly customizable and/or controllable. Such host computer programs include complex graphics-manipulation programs, word processing programs, email programs, and other types of computer programs. Such host computer systems include Internet servers, such as those that provide desktop-like functionality, email functionality, mapping functionality, and photo-sharing functionality, and other types of computer systems. Traditionally, these hosts expose their capabilities via an application programming interface (API), including the types of objects they support and the types of actions that can be performed in relation to the objects.

Within the prior art, the API's of hosts are accessed using a text-based computer programming language, such as BASIC, Pascal, C, C++, and so on, or a text-based scripting language, such as JavaScript, Perl, Python, VBScript, and so on. To access a host API to customize or control the host in question, a user thus has to be versed in a given programming language or scripting language. Many end users, however, are not fluent in such programming and scripting languages. As such, they are not able to utilize the customization and control capabilities provided by hosts.

Furthermore, developers can also have difficulties accessing host API's when controlling a host. For instance, developers are typically faced with a plethora of different computer programming languages and scripting languages, each with its own grammar and rules. As such, developers may be inclined to only customize and control hosts that provide API's in the language(s) in which they are best versed. As a result, developers may not use all the different hosts that are potentially available to them.

For this and other reasons, therefore, there is a need for the present invention.

### SUMMARY OF THE INVENTION

The present invention relates to providing a graphical user interface (GUI) for navigating and manipulating objects exposed by a host, such as a host computer program or a host computer system. In one embodiment, an application programming interface (API) of the host is accessed to receive a list of hierarchically organized objects that the host supports. Each object has one or more attributes supported thereby and/or one or more operations supported thereby. A GUI is provided by which a user is to navigate a plurality of the objects to select one or more desired objects. A GUI is also provided by which the user is to manipulate the attributes and/or the operations of the objects selected. The host is manipulated based at least on the objects selected as to which the attributes and/or the operations thereof have been manipulated.

In one embodiment, a GUI is additionally provided by which the user is to manipulate a dynamic attribute of a selected object. The dynamic attribute returns the selected object, or another object, when the dynamic attribute is actually evaluated. In one embodiment, a GUI is also provided by which the user is to create one or more variables that are used when manipulating the host. The host is thus manipulated based at least on the objects selected and the variables created. In one embodiment, a GUI is further provided by which the user is to create one or more logic constructs and/or one or more loop constructs. The host is thus manipulated based at least on the objects selected and the logic constructs and/or the loop constructs created.

Embodiments of the invention provide for advantages over the prior art. Whereas in the prior art a user has to be versed in a given computer programming language or a given computer scripting language in order to control or customize a host computer program or a host computer system, embodiments of the invention do not require the user to have to know a computer programming or scripting language. Rather, the user is able to access and manipulate objects exposed by a host via a GUI. Therefore, the user is able to control or customize the host without having to resort to a text-based programming or scripting language. Some embodiments of the invention allow the user to create variables, logic constructs, and/or loop constructs, and/or to manipulate dynamic attributes of objects, by which the host may further be controlled or customized.

Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system, according to an embodiment of the invention.

FIGS. 2A, 2B, and 2C are flowcharts of a method, according to an embodiment of the invention.

FIGS. 3A and 3B are diagrams of a hierarchy of objects and a path of objects ending in a desired selected object, respectively, according to an embodiment of the invention.

FIGS. 4A, 4B, and 4C are diagrams illustratively depicting how a GUI is provided by which a user navigates a hierarchy of objects to select a desired object, according to an embodiment of the invention.

FIGS. 5A and 5B are diagrams illustratively depicting how a GUI is provided by which a user manipulates the attributes and operations of a desired object that has been selected, according to an embodiment of the invention.

FIGS. 6A and 6B are diagrams illustratively depicting how a GUI is provided by which a user manipulates a dynamic attribute of a desired object that has been selected, according to an embodiment of the invention.

FIGS. 7A and 7B are diagrams illustratively depicting how variables can be created, according to an embodiment of the invention.

FIGS. 8A, 8B, and 8C are diagrams illustratively depicting how variables can be used, according to an embodiment of the invention.

FIGS. 9A, 9B, and 9C are diagrams illustratively depicting how logic constructs and loop constructs can be created, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

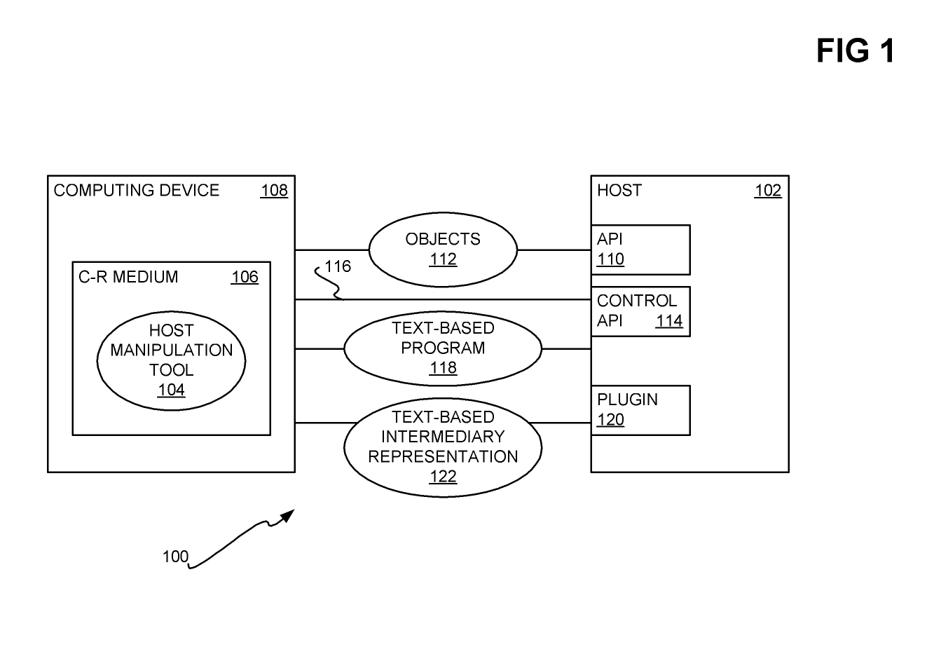

FIG. 1 shows a representative system 100, according to an embodiment of the invention. The system 100 includes a host 102 that is to be controlled or customized by employing a graphical user interface (GUI), as will be described. The host 102 may be a host computer program, a host computer system, or another type of host. For instance, the host 102 may be a complex graphics-manipulation computer program, or another type of computer program. As another example, the host 102 may be an Internet server, or another type of computer system.

The system 100 further includes a host manipulation tool 104 by which the host 102 is controlled or customized using a GUI. The host manipulation tool 104 may be software, hardware, or a combination of software and hardware. The tool 104 is specifically depicted in FIG. 1 as being a computer program stored on a computer-readable medium 106. The medium 106 is a tangible computer-readable medium, such as a recordable data storage medium, a volatile semiconductor memory, or another type of computer-readable medium. The medium 106 is specifically depicted in FIG. 1 as being part of, residing in, or being inserted within a computing device 108. As can be appreciated by those of ordinary skill within the art, the computing device 108 may include one or more processors, memory, and other components, which are not specifically shown in FIG. 1.

In one embodiment, the host 102 exposes an application programming interface (API) 110 by which it delineates a list of hierarchically organized objects 112 that the host 102 supports. Each of the objects 112 may have one or more attributes and/or one or more operations that can be performed in relation to the attributes or the object itself An API may be generally and non-restrictively defined as a language and/or message format used by the host 102 to communicate with another program or system. An object may be generally and non-restrictively defined as a self-contained module of data and its associated processing.

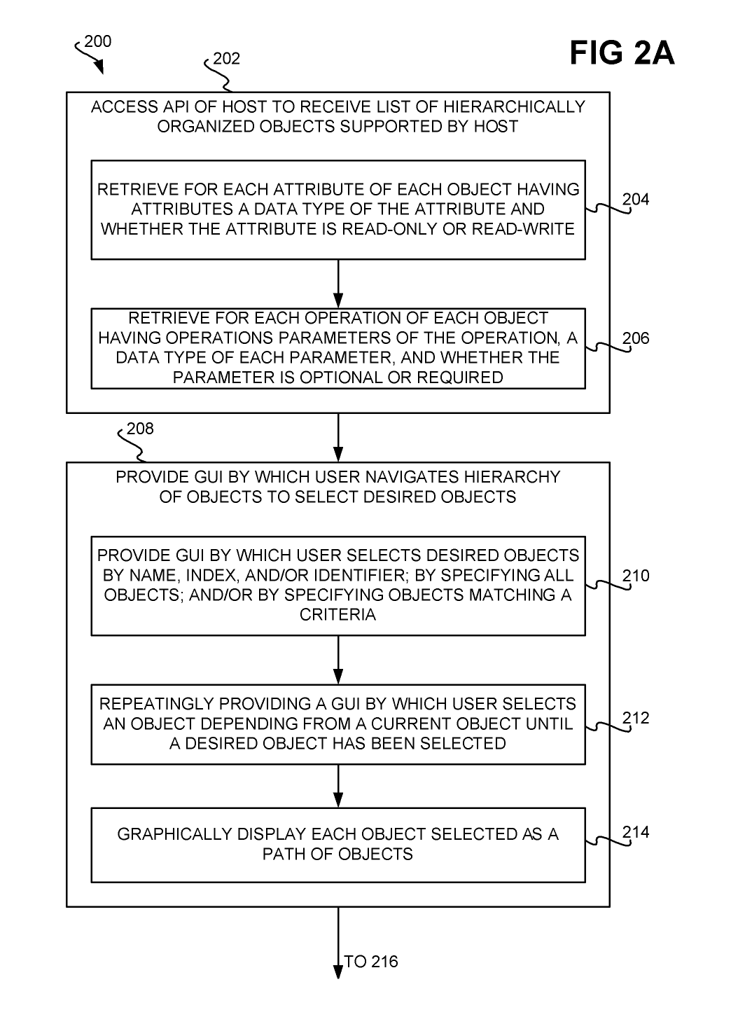

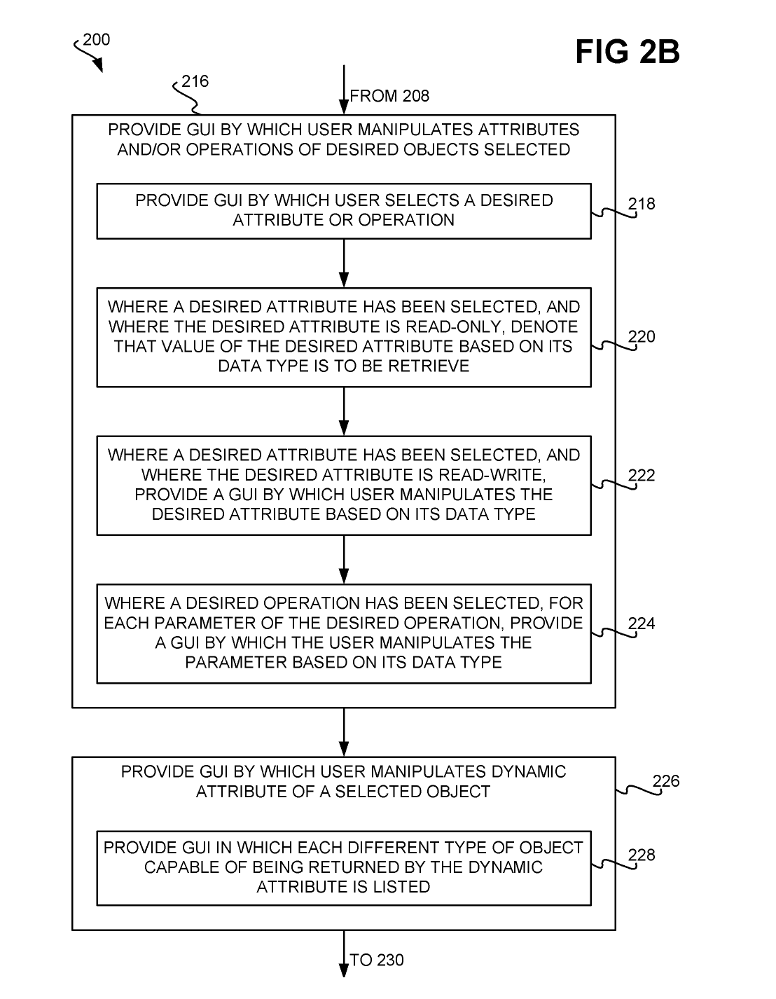

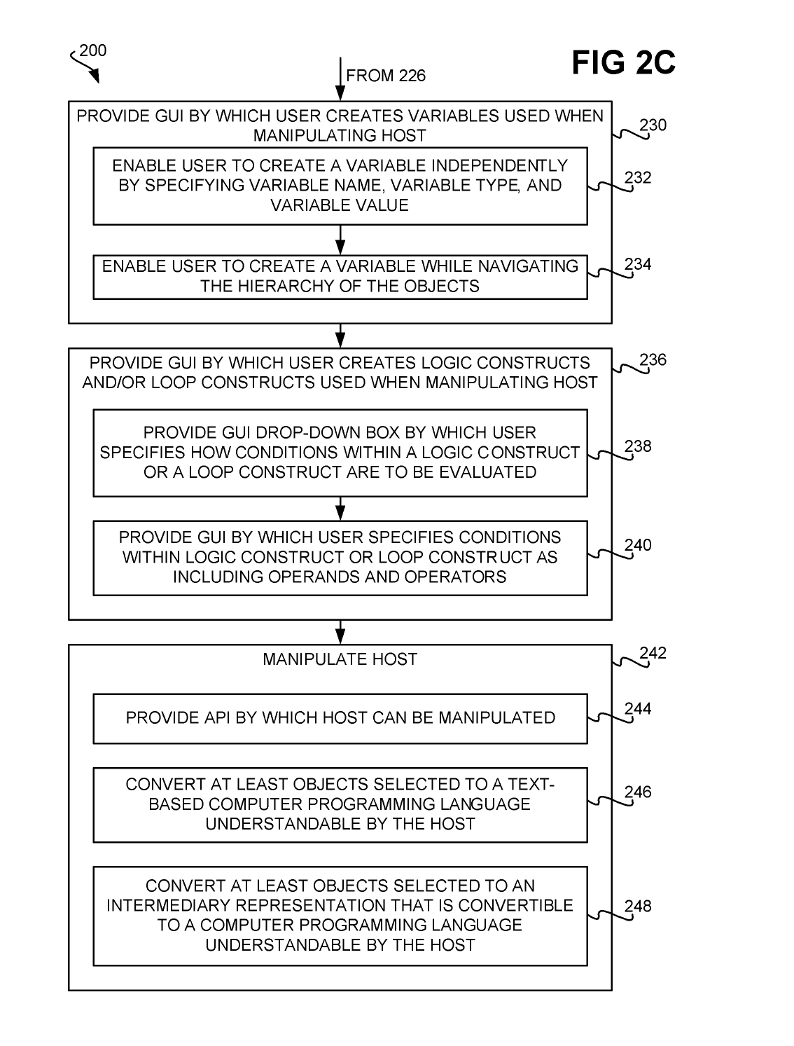

The manner by which the objects 112 are navigated and manipulated by a user employing a GUI provided by the host manipulation tool 104 in order to control and customize the host 102 is described in particular relation to the method 200 of FIGS. 2A, 2B, and 2C later in the detailed description. Once the user has manipulated the objects 112 in a desired manner, the host 102 is then controlled or customized in accordance therewith, which is referred to generally herein as manipulating the host 102. In one embodiment, one of three different approaches may be used to manipulate the host 102 in this way. For any of these approaches, the manipulations can be contained within a file, or it can be transmitted over a network. In the latter case, each manipulation can be sent individually, as would be employed within a debugging scenario where the user is analyzing what each manipulation does, or the entire group of manipulations can be sent at once.

First, the host 102 may expose a control API 114 by which the manipulated objects 112 can be directly used to manipulate the host 102, as indicated by the line 116. That this, the API 114 is exposed by the host 102 so that the host manipulation tool 104 can manipulate the host 102 in a way understandable by the host manipulation tool 104. For example, inter-process communication, such as by using the simple object access protocol (SOAP), may be achieved. The inter-process communication may be on the same computing device, or across a network between two (or more) computing devices, such as over the Internet.

Second, the host manipulation tool 104 may generate a text-based computer program 118 based on the manipulated objects 112, in accordance with a text-based computer programming language, and that is understandable by the host 102. An example of this may be a program formatted in a markup-language, such as the eXtensible Markup Language (XML), for instance. Other types of programs can also be generated. In either the first approach or the second approach, a plug-in may be installed within the host 102 by which the host 102 is manipulated as described. A plug-in can be generally and non-restrictively defined as an auxiliary computer program that works with the host 102 to enhance its capability.

Third, the host manipulation tool 104 may generate a text-based intermediary representation 122 based on the manipulated objects 112 but that is not directly understandable by the host 102. The intermediary representation 122 may be formatted in accordance with a scripting language, such as JavaScript, or another type of scripting language, that the host 102 understands.

FIGS. 2A, 2B, and 2C show a method 200 that is employed to navigate and manipulate the objects 112 exposed by the host 102, according to an embodiment of the invention. In substantial part, the method 200 is performed by the host manipulation tool 104. Thus, the method 200 may be implemented as one or more computer programs, stored on a tangible computer-readable medium, in one embodiment of the invention. It is noted that while the various parts of the method 200 are depicted as occurring in a certain order in FIGS. 2A, 2B, and 2C, this order is for representative, descriptive, and arbitrary purposes only, and does not limit the only actual order in which the parts of the method 200 can be performed.

An API of the host 102 is accessed to receive a list of the hierarchically organized objects supported by the host 102 (202). For each object, the name of the object and a short description of the object may be provided. The hierarchy of the objects may be provided by, for each object, identifying the objects that directly depend from the object. For each object, a list of one or more attributes supported by the object may be provided, as well as a list of one or more actions supported by the object.

For each attribute of each object that has attributes, then, the method 200 retrieves the data type of the attribute and whether the attribute is read-only or read-write (204), in addition to the name and a description of the attribute. More specifically, each attribute can have a data type of what the attribute returns, and a data type of what the attribute accepts. Alternatively, an attribute may have just one data type for both. Each such data type may further in actuality be a list of data types. Each such data type may thus specify whether the attribute is an integer, a real number, a string, a character, and so on. A read-only attribute is an attribute that is specified by the host 102 itself, and which cannot be modified. By comparison, a read-write attribute can be modified.

Likewise, for each operation of each object that has operations, the method 200 retrieves one or more operation parameters, a data type of each parameter, and whether the parameter is optional or required (206), in addition to the name and a description of the object. Operations are generally actions that can be performed by the object, performed to the object, or otherwise performed in relation to the object. Each parameter may include a parameter name and a description, where a parameter is generally a data value that specifies how the operation is to perform its given action. The parameter's data type may further be an integer, a real number, a string, a character, and so on. An optional parameter is one that does not have to be specified for the operation to perform its given action, whereas a required parameter has to be specified.

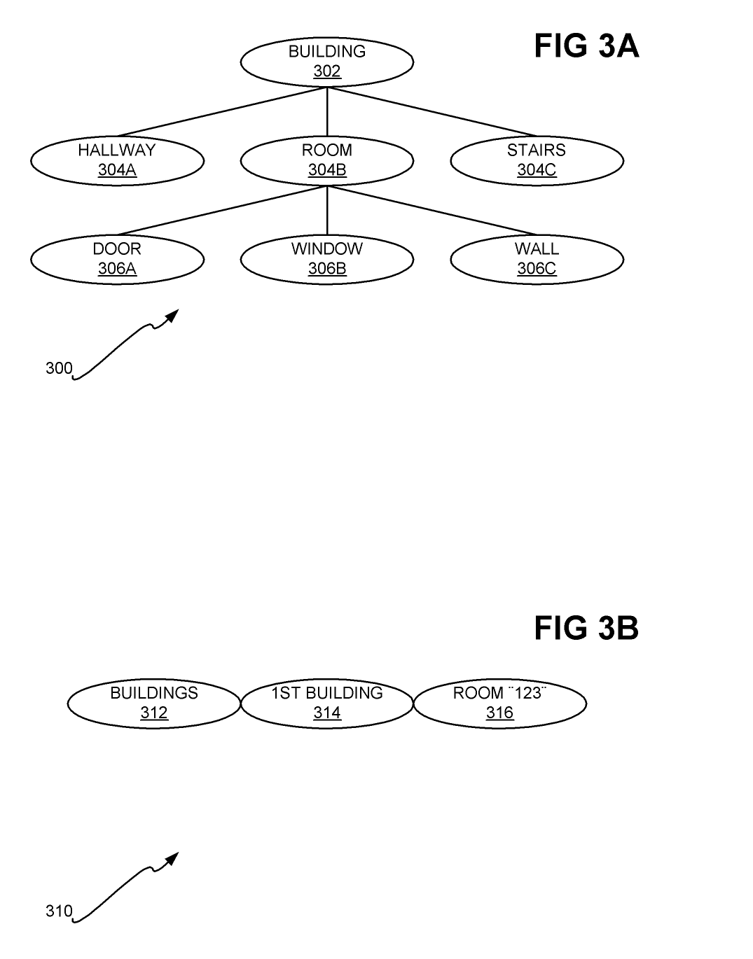

An example of performance of an embodiment of the invention is described in relation to a “system” that is particularly a building. While embodiments of the invention are described in relation to such an example system, those of ordinary skill within the art can appreciate that the invention itself is not limited to performance in relation to this particular system, which is presented here as an easy-to-understand example. FIG. 3A therefore shows such an example hierarchy 300 of objects, according to such an embodiment of the invention.

The hierarchy 300 of objects includes an object 302; objects 304A, 304B, and 304C, collectively referred to as the objects 304; and, objects 306A, 306B, and 306C, collectively referred to as the objects 306. The object 302 specifies a building. The objects 304 are children objects depending directly from the object 302, where the object 304A specifies a hallway of a building, the object 304B specifies a room of a building, and the object 304C specifies stairs of a building. Finally, the objects 306 are children objects depending directly from the object 302, where the object 306A specifies a door of a room, the object 306B specifies a window of a room, and the object 306C specifies a wall of a room.

It is noted that there may be more than one of the object 302, that there may be more than one of each of the objects 304 for a given building object, and that there may be more than one of each of the objects 306 for a given room object. The objects 306 directly depend from the object 304B, and thus indirectly depend from the object 302. Therefore, it can be said that the objects 306 are children objects of the object 302, albeit not direct children, but rather indirect children, or grandchildren. It is noted that a number of objects may be organized in a different way than as a hierarchy of objects. For instance, a host may expose just one level of objects. As such, these objects are organized as a list of objects, as opposed to a hierarchy of objects.

Referring back to FIG. 2A, a GUI is provided by which a user navigates the hierarchy of objects to select one or more desired objects (208). In particular, part 208 of the method 200 can include providing a GUI by which a user selects desired objects by name, index, and/or an identifier; by specifying all objects; and/or, by specifying those objects that match one or more given criteria (210). Selecting an object by its name means entering or selecting the name of an object, such as “Building 1,” and so on. Selecting an object by index means specifying a first object, a second object, a third object, and so on. Thus, selecting an object by matching one or more given criteria means specifying an object based on its attributes, such as a room with a certain color, and so on. An object may further be selected by data or a variable that specifies an object.

Part 208 of the method 200 can further include, in lieu of and/or in addition to part 210, repeatingly providing a GUI by which the user selects in an iterative or recursive manner an object depending from a current object, which becomes the new current object, until a desired object has been selected (212). That is, the user selects a top-most, or highest-level object, and the objects depending from this selected current object are then displayed. The user repeats this process until the desired object is located and selected. Regardless of whether part 210 and/or part 212 is performed, part 208 can include graphically displaying each object selected as a path of objects (214), based on the hierarchy of objects.

FIG. 3B shows representative display of the end result of performance of part 208 of the method 200 (particularly part 214 of the method 200), according to an embodiment of the invention. A path of objects 310 is ultimately displayed. The object 316 is the selected object, specifying “Room 123.” The object 316 may have been selected by the user via performance of part 210 and/or part 212 of the method 200. The object 316 directly depends from the object 314, which specifies the “1^{st} Building.” The object 314 directly depends from host 312, which specifies the host encompassing buildings. The path 310 thus proceeds in one embodiment from left to right, where the hierarchically greatest object is at the left, and the hierarchically least (and the desired and selected) object is at the right. Alternatively, the path 310 may proceed from right to left, from top to bottom, from bottom to top, or in another way.

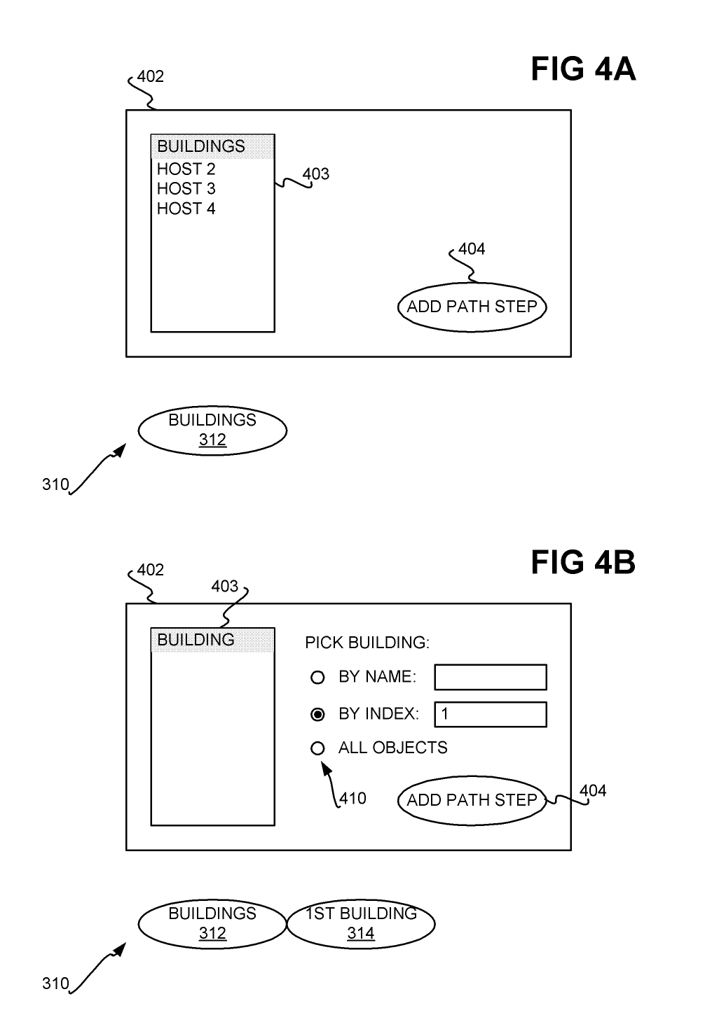

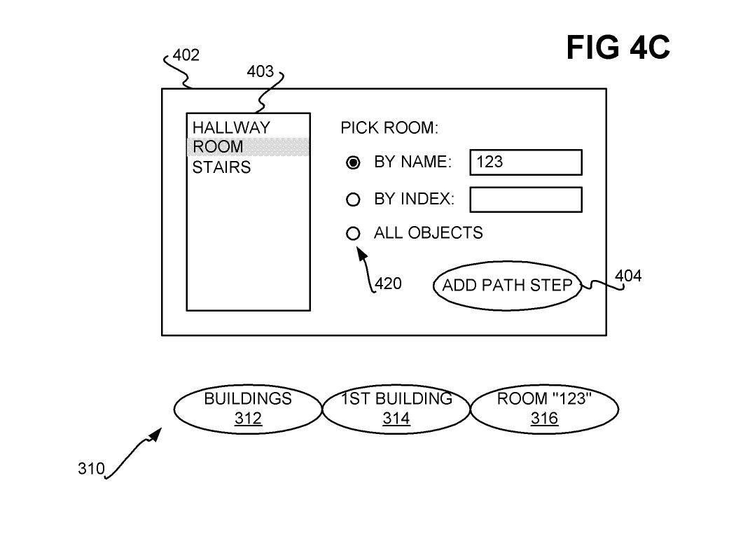

FIGS. 4A, 4B, and 4C show representative performance of parts 210, 212, and 214 of the method 200, according to an embodiment of the invention. Referring first to FIG. 4A, a GUI 402 is provided in which a scrollable list box 403 is displayed. The list box 403 in FIG. 4A shows the top-level hosts that are available, including, for instance, “Buildings,” “Host 2,” “Host 3,” and “Host 4.” A user is able to select any of these four hosts by highlighting the desired object, and selecting the button 404. As a result of the button 404 being selected, the selected host 312 is displayed in the path of objects 310.

Referring next to FIG. 4B, the “Building” object is solely displayed within the list box 403 of the GUI 402. This is because within the “Buildings” host, the only top-level objects are “Building” objects. The user is presented with a list of radio buttons 410 to select a building by name, by index, or to select all these types of objects. In the example of FIG. 4B, the user has selected a building by index, such that he or she has entered the number “1.” As a result of the user selecting the button 404, the selected object 314, specifying the “1^{st} Building,” is displayed in the path of objects 310.

Referring next to FIG. 4C, all three children objects to the “1^{st} Building” object are now displayed within the list box 403 of the GUI 402. The user is able to select any of these three objects by highlighting the desired object. The list of radio buttons 420 changes depending on whether a hallway object, a room object, or a stairs object is selected. For instance, some objects may not have a name, and thus the name radio button would not appear for such objects. In the example of FIG. 4C, the user has selected a room object, where the list of radio buttons 420 enables the user to select a particular room by name, by index, or to select all objects of this type. In FIG. 4C, the user specifically has selected the Room “123.” Upon the user selecting the button 404, the selected object 316, specifying “Room 123,” is displayed in the path of objects 310.

Thus, FIGS. 4A, 4B, and 4C show how a user is able to navigate a hierarchy of objects to select a desired object in part 208 of the method 200. In particular, part 210 of the method 200 is illustrated in FIGS. 4A, 4B, and 4C, since the user is able to select a desired object by name, by index, or by selecting all objects of a given type. Furthermore, part 212 of the method 200 is illustrated in FIGS. 4A, 4B, and 4C, since once the user has selected a host in FIG. 4A, the top-level objects thereof are depicted in FIG. 4B, and once the user has selected a top-level object in FIG. 4B, the children objects of this object are depicted in FIG. 4C for selection of a desired object by the user. As the user selects objects, the path of objects displayed in part 214 of the method 200 is updated.

It is noted that when the user is selecting desired objects via a GUI, that the number of objects that the host exposes may be exceedingly large, inhibiting the user's ability to easily select the desired objects. Therefore, in one embodiment, a search box may be provided, by which the user narrows down the list of objects based on the objects' names and/or descriptions, before selecting the desired objects. In another embodiment, the objects may be organized into a number of categories. Thus, a user first selects a category, and then is able to select one or more of the desired objects from the category selected. These two approaches may be used alone or together, and assist the user in easily selecting the desired objects.

Referring to FIG. 2B, a GUI is provided by which a user manipulates attributes and/or operations of the desired objects selected (216). In particular, a GUI is provided by which a user selects a desired attribute or operation (218). If a desired attribute has been selected, and the desired attribute is read-only, then the value of the desired attribute, based on its data type, may be indicated as being retrieved, such as by being stored in a variable, or being used in a logic or loop constructed (220). If a desired attribute has been selected, but the desired attribute is read-write, then a GUI is provided by which the user can retrieve (i.e., read) the desired attribute, and/or can manipulate the desired attributed, based on its data type (222). Similarly, if a desired operation has been selected, a GUI is provided by which the user manipulates each parameter of the desired operation, based on the parameter's data type (224).

Thus, for read/write attributes and for parameters of an operation, the GUI that is provided by which the user manipulates an attribute or a parameter of an operation varies depending on the data type of the attribute or the parameter in question. For instance, if the attribute or parameter is Boolean that accepts Yes/No, True/False, and so on, then a checkbox is displayed in which the user can check one of the two options. If the attribute or parameter allows picking an item from a list, then a popup or dropdown menu is displayed from which the user selects an item from a list of displayed items. If the attribute or parameter accepts a list of data, then a plus (“+”) button and a (“−”) button may be displayed that allow the user to add or remove items from the list. If the attribute or parameter is a file, then an edit box is displayed to allow the user to enter the file path, and a button is displayed to allow the user to browse a given repository of files.

Furthermore, if the attribute or parameter is another object, then a button may be displayed that when select displays a new window in which the user can navigate the hierarchy of objects to select the object, similar to the approach that has been described in relation to FIGS. 4A-4C for selecting a desired object. If the attribute or parameter can accept more than one type of data, then a popup menu is displayed delineating those types. Once the user has selected a given type, then the GUI changes to allow selection of the value for the attribute or parameter based on that type. Thus, the GUI is modifiable and dynamic, and changes based on the data type of the attribute or parameter in question of the object that has been selected.

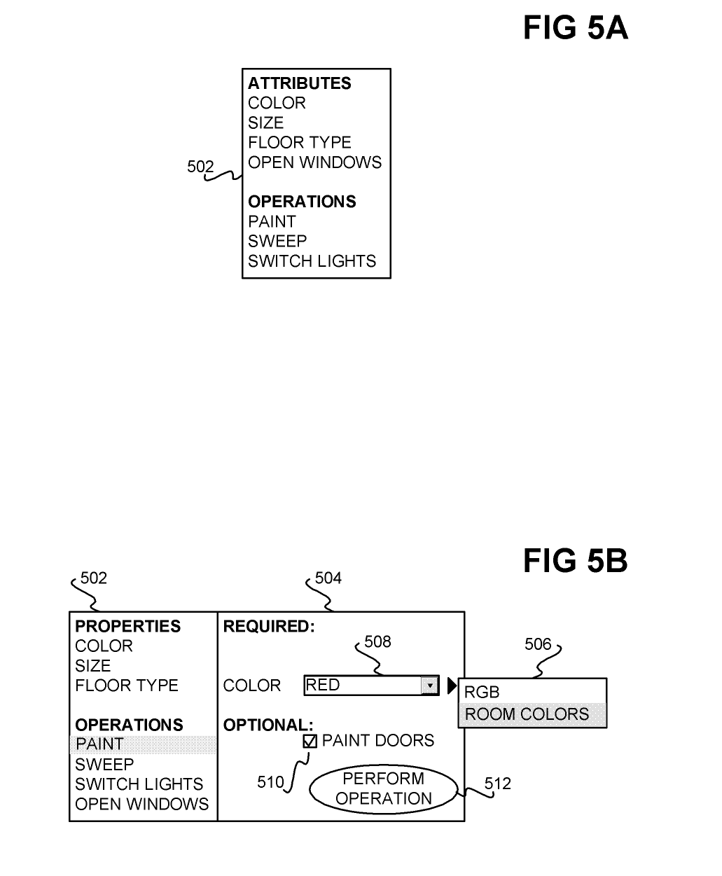

FIGS. 5A and 5B show representative performance of part 216 of the method 200 (specifically parts 218 and 224), according to an embodiment of the invention. Referring first to FIG. 5A, a GUI 502 is provided in which the attributes of and the operations performable in relation to a room object are displayed as a scrollable list. The user is able to select an attribute or an operation from this list. For instance, the user may select the operation “Paint.”

In response, referring to FIG. 5B, an additional GUI 504 is provided in which the parameters of this operation are displayed for manipulation by the user. The operation “Paint” has one required parameter, the color of the paint that is to be used, and one optional parameter, whether the doors are to be painted. The data type of the color parameter is flexible, such that a popup menu 506 is displayed by which a user can select from a list of preset room colors, or can specify a color by its red, green, and blue (RGB) values. In the example of FIG. 5B, the user has selected that the list of preset room colors be displayed. As such, a dropdown menu 508 is displayed from which the user can select a particular preset color, such as red.

The data type of the paint doors parameter is Boolean, such that either the doors are painted, or they are not. As a result, a checkbox 510 is displayed. If the user selects the checkbox 510, then the doors will be painted. Otherwise, the doors within the room in question will not be painted.

Referring back to FIG. 2B, a GUI can further be provided by which a user manipulates dynamic attributes of a selected object (226). Thus, the host can be manipulated based on the objects selected, as to which the attributes, operations, and dynamic operations thereof are manipulated. It is noted that the attributes described in relation to part 216 are static attributes. That is, the values that such attributes can take on cannot change in their data type once they have been configured. A file attribute always specifies a file, an integer attribute always specifies an integer, and so on. By comparison, a dynamic attribute may or may not return a value having the same data type as before, such that it is not pre-configured. Furthermore, a dynamic attribute can potentially return a different data type each time it is evaluated.

For example, a “Building” object may have a “most populated” attribute that can return the room, hallway, or stairs currently having the most number of people. When this attribute is part of a path of objects, the target specified by the path becomes dynamic. Each time the host is requested for the “most populated” object, a different type of object may be returned depending on which room, hallway, or stairs is currently most populated by people. Because a room object is a different type of data object than a hallway object, and a hallway object is a different type of data object than a stairs object, this attribute is dynamic, since it does not always return a value (i.e., the identification of an object) having the same data type. Thus, evaluation of the dynamic attribute is capable of returning a different type of object based on the current status of dynamic attribute.

In one embodiment, part 226 is performed by providing a GUI in which each different type of object capable of being returned by the dynamic attribute in question is listed (228). The user can then select one of the object types listed, and select an attribute, operation, or indeed an object off that object type. Ultimately, however, what matters with a dynamic attribute is the last element selected, be it an attribute, operation, or an object. As such, a different type of object, or no object, may be returned, based on whether the object in question possesses the last element selected. An example of this is now presented.

A room object may have four types of direct children objects: a closet object, a door object, a wall object, and a window object, whereas a hallway object may have three types of direct children objects: a door object and a fire alarm object, and a stairs object may have two types of direct children objects: a door object and a fire alarm object. The dynamic attribute of a building object may specify a room object, a hallway object, or a stairs object that is currently most populated by people. If the user particularly selects the fire alarm object off this dynamic attribute, then the user has implicitly indicated that the dynamic attribute has to specify a hallway object or a stairs object, since a room object does not have a child fire alarm object.

Therefore, if during evaluation of the dynamic attribute a room object is selected, which does not have a fire alarm object, an embodiment of the invention can proceed in one of a number of different ways. First, the user can be alerted that the dynamic attribute returned an object that does not have a fire alarm object. That is, the user can be alerted that the object returned is unexpected in relation to that which has been selected by the user. This is because the user has selected the fire alarm object off the dynamic attribute, but upon evaluation of the dynamic attribute, the dynamic attribute returned an object, a room object, that does not have a fire alarm object as a child object. Second, the aspect of the user's manipulation relating to this dynamic attribute can be simply ignored if it returns an expected object type.

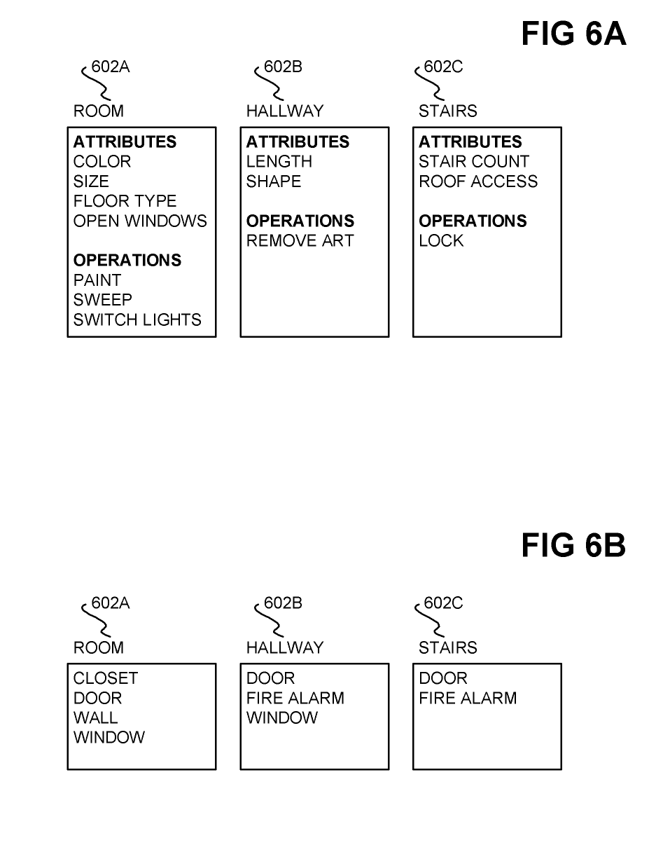

FIGS. 6A and 6B show representative performance of part 226 of the method 200 (specifically part 228), according to an embodiment of the invention. In both FIGS. 6A and 6B, it is presumed that the user has selected a “most populated” dynamic attribute of a building object. In response, in FIG. 6A, a list of all three objects 602A, 602B, 602C, that can be returned by this dynamic attribute is displayed, which specifically includes the attributes and operations of each of these objects. Thus, a user can select an attribute or an operation of a room object, a hallway object, or a stairs object off the “most populated” dynamic attribute of a building object.

In addition or in lieu of FIG. 6A, as is depicted in FIG. 6B, a list of all three objects 602A, 602B, and 602C that can be returned by this dynamic attribute is displayed, which specifically includes the children objects of each of these objects. Thus, a user can select a child object of a room object, a hallway object, or a stairs object off the “most populated” dynamic attribute of a building object. It is noted that while the lists of FIGS. 6A and 6B are depicted horizontally, they may alternatively be displayed in a vertical manner.

Referring now to FIG. 2C, a GUI can be provided by which the user creates variables that are employed when manipulating the host (230). Thus, the host is manipulated based at least on the objects selected, as to which the attributes and operations thereof have been manipulated, and on the variables created. Variables can be created in one or more of two different ways. First, a user can be enabled to create a variable independently, by specifying a variable name, a variable type, and a variable value (232). Second, a user can be enabled to create a variable while navigating the hierarchy of objects (234), such that the variable results from manipulating an attribute or an operation of a selected object. Each of these different ways is now described by example.

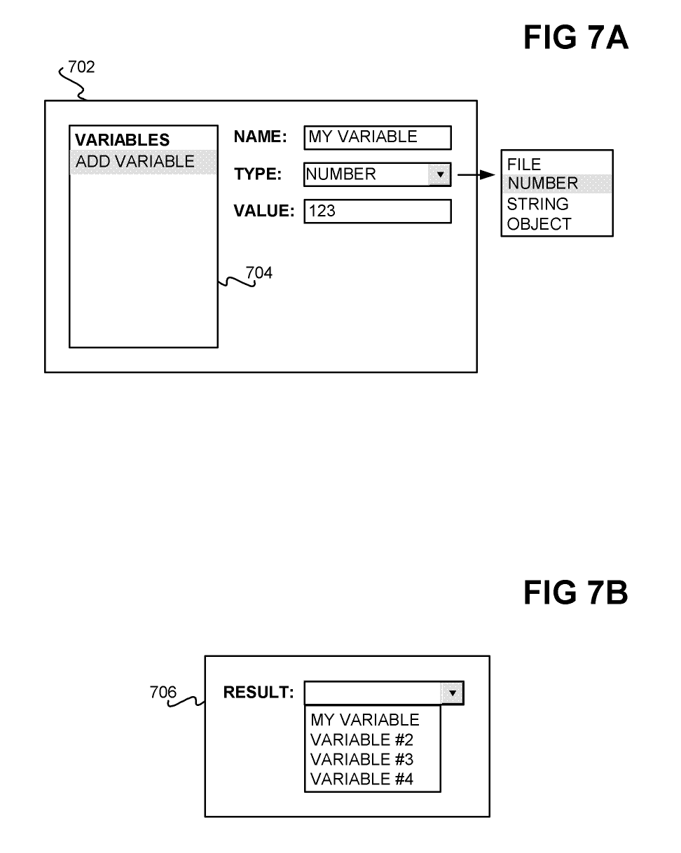

FIG. 7A shows representative performance of parts 230 and 232 of the method 200, according to an embodiment of the invention. Specifically, FIG. 7A shows how a variable can be independently created. A GUI 702 is provided, in which in a list of variables 704, an “Add Variable” option is selectable by the user. The user selects this option, and then is able to enter the name of the variable, the type of the variable via a dropdown menu, and the value of the variable in accordance with its type.

FIG. 7B shows representative performance of parts 230 and 234 of the method 200, according to an embodiment of the invention. Specifically, FIG. 7B shows how a variable can be created while navigating the hierarchy of objects. It is presumed that the user has selected an attribute or an operation of a desired object that produces a result. In response, a GUI 706 can be presented, by which the user can set this result equal to an already defined variable, or by selecting a new variable, such as “variable #2,” “variable #3,” and so on. Upon selecting a new variable, the data type of the variable may be automatically specified based on the data type of the result of the attribute or operation in question. The user may be provided with the opportunity to name the variable, however.

It is noted that variables may further be used in one of two different ways. First, when the GUI is provided by which the user is to navigate the hierarchy of objects, as has been described, the user may be presented with the variables created as selectable by the user. That is, the user can navigate the variables while navigating the objects, and also use the variables when navigating the objects, in each case being presented with the variables that have been previously created. Second, when the GUI is provided by which the user is to manipulate the attributes and/or the operations of a selected object, the user may be presented with the variables creates as selectable by the user to manipulate these attributes and/or operations. Each of these two different ways is now described by example.

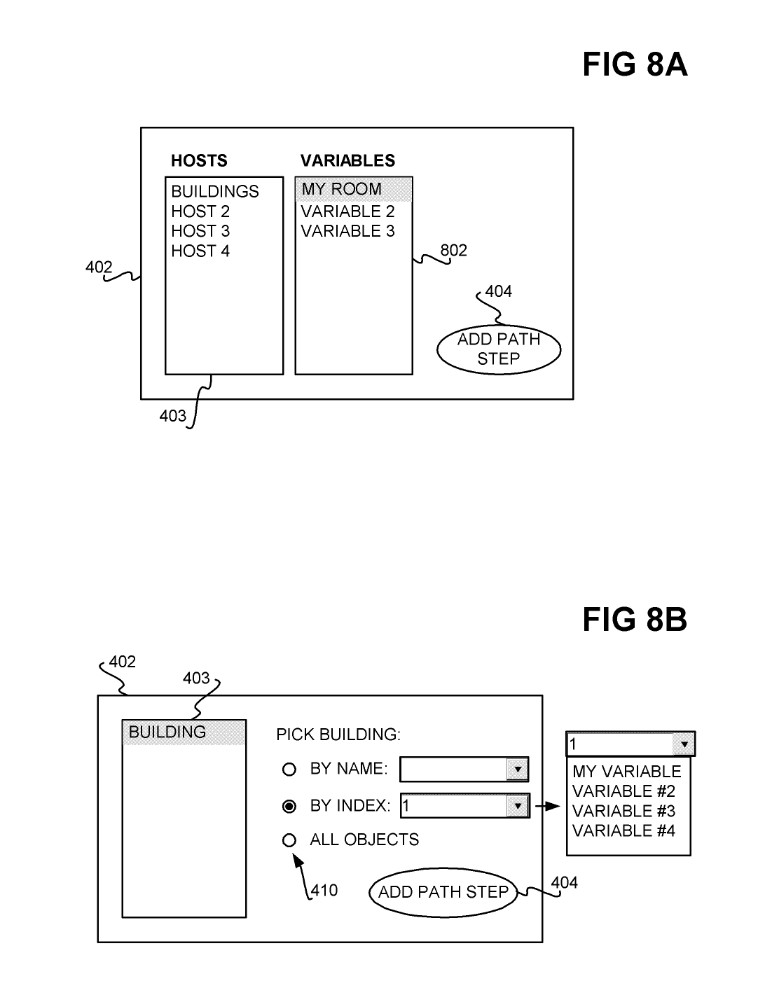

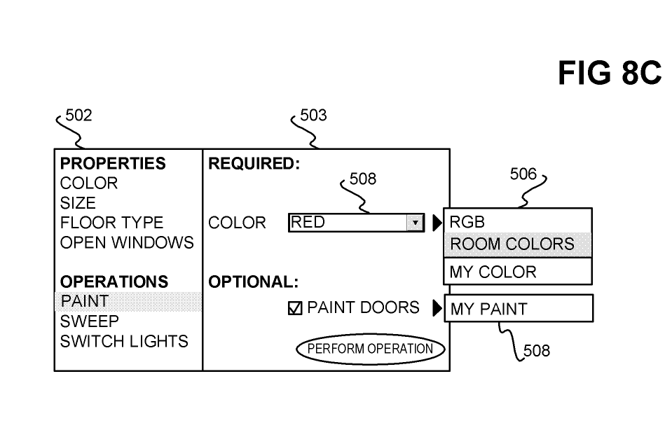

FIG. 8A shows how the user is able to navigate the variables that have been created while navigating the hierarchy of objects, according to an embodiment of the invention. In particular, the GUI 402 of FIG. 4A is presented in which, in addition to the list of hosts 403 being displayed, a list of variables 802 is displayed. The user can thus select a variable instead of selecting a host, and then select the button 404 as before. That is, a variable can be used as the starting point of a path of objects, instead of a host.

FIG. 8B also shows how the user is able to use variables when navigating the hierarchy of objects, according to an embodiment of the invention. In particular, the GUI 402 of FIG. 4B is presented in which a user is able to specify a particular building object by index, where there is a combination GUI element associated with the index radio button 410 that shows a dropdown list of created variables in addition to a box allowing a user to enter in the index number manually. The user can thus select a variable to navigate to a particular building object by index instead of having to enter the index number manually.

FIG. 8C shows how the user is able to manipulate the attributes and/or the operations of a selected object by using variables, according to an embodiment of the invention. In particular, the GUI's 502 and 504 of FIG. 5B are presented. As to the required color parameter of the selected paint operation, the user can select a variable entitled “My Color” in addition to one of the room colors or manually specifying a color by RGB, via the popup menu 506. Furthermore, as to the optional “paint doors” parameter of the selected paint operation, the user can select that the doors be painted with user-supplied paint or not, where the variable “My Paint” is a Boolean variable specifying that user-supplied paint is being provided. If the user selects the variable “My Paint” in relation to the “paint doors” parameter, and if the “My Paint” variable is true, then the doors of the room in question will be painted with the user-supplied paint. If this variable is not selected, or if the variable is selected but is false, then the doors of the room will not be painted with user-supplied paint.

Referring back to FIG. 2C, a GUI can also be provided by which the user creates logic constructs and/or loop constructs that are used when manipulating the host (236). As such, the host is manipulated based at least on the objects as are manipulated, and on the logic constructs and/or the loop constructs created. A logic construct is basically an IF-THEN construct, where if one or more operands are true when evaluated, as may be joined by AND, OR, or another type of operator, then one or more actions are performed. Optionally, the logic construct may contain an ELSE clause, listing one or more actions to be performed where the conditions are not true when evaluated. A loop construct may be a REPEAT-UNTIL construct or a WHILE construct, where in the former one or more actions are repeated until one or more conditions are true, and in the latter while one or more conditions are true one or more actions are repeatedly performed.

In one embodiment, the GUI provided includes providing a GUI dropdown box by which the user specifies how conditions within a logic construct or a loop construct are to be evaluated (238). The GUI provided may also include providing a GUI by which the user specifies conditions within the logic construct or loop construct as including operands and operators (240). Both of these ways to specify logic constructs and/or loop constructs are now described in illustrative detail.

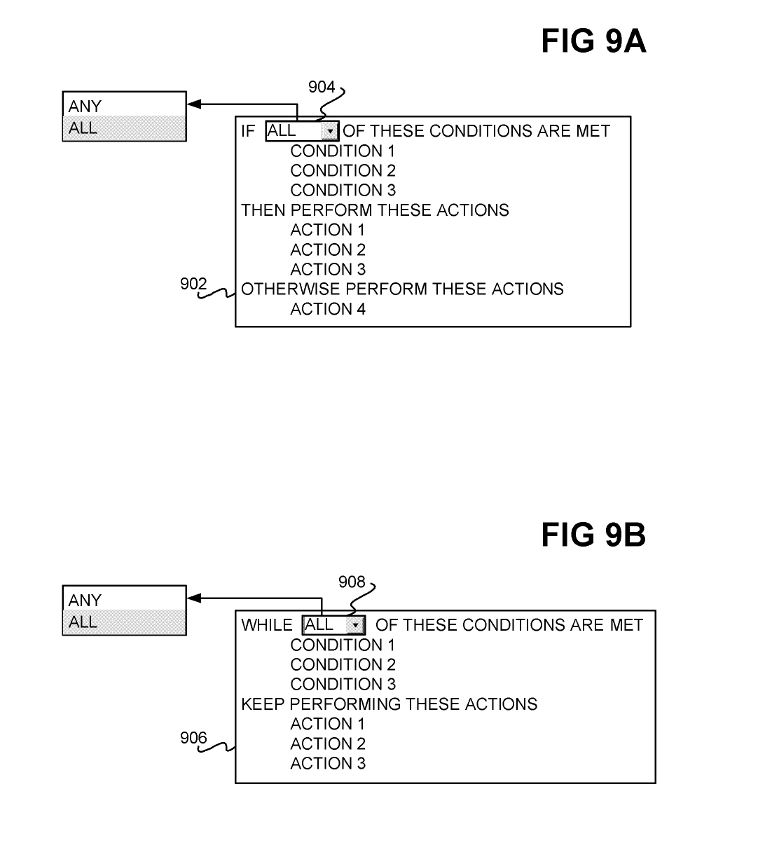

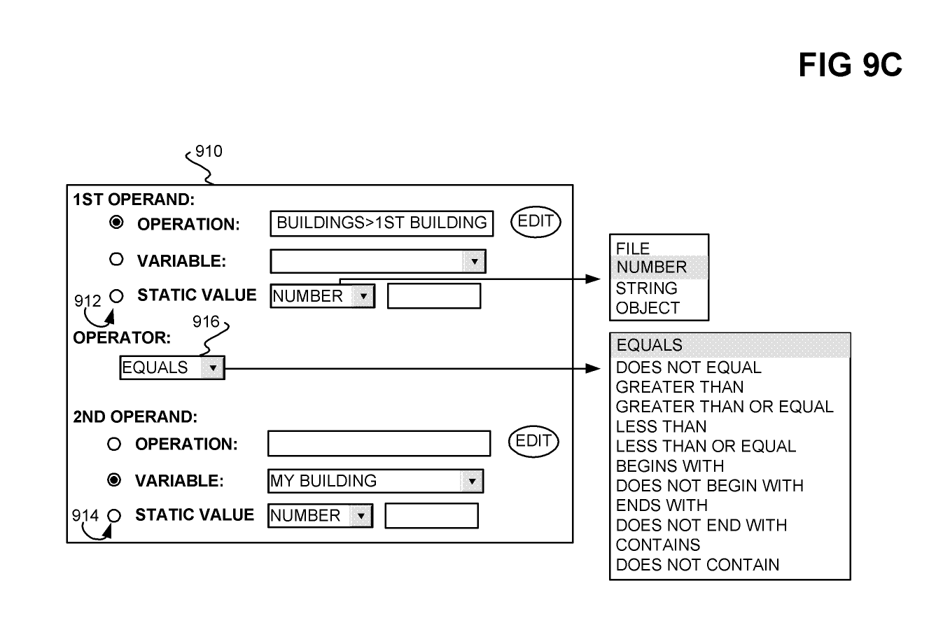

FIG. 9A shows representative performance of parts 236 and 238 of the method 200 for creating a logic construct, according to an embodiment of the invention. Specifically, FIG. 9A shows a GUI 902 in which a user is able to specify a number of conditions, and specify a number of actions if those conditions are satisfied in a particular way, and a number of actions that may be performed if the conditions are not satisfied in the particular way. The manner by which conditions can be created is described later in the detailed description. However, the dropdown box 904 allows the user to select whether any of the conditions have to be satisfied—which is basically an OR statement—or whether all of the conditions have to be satisfied—which is basically an AND statement.

FIG. 9B shows representative performance of parts 236 and 238 of the method 200 for creating a loop construct, according to an embodiment of the invention. Specifically, FIG. 9B shows a GUI 906 in which a user is able to specify a number of conditions, and specify of number of actions that are repeatedly performed while the conditions are satisfied in a particular way. The manner by which conditions can be created is described later in the detailed description. However, the dropdown box 908 allows the user to select whether any of the conditions have to be satisfied, or whether all of the conditions have to be satisfied.

FIG. 9C shows representative performance of parts 236 and 240 of the method 200 for creating a condition for a logic construct or a loop construct, according to an embodiment of the invention. Specifically, FIG. 9C shows a GUI 910 in which a user is able to specify a first operand via the radio boxes 912 and a second operand via the radio boxes 914. Each operand may be specified by an operation, where the object hierarchy is navigated, and the resulting target object used for the value of the operand. Each operand may also be specified by an operation where an object hierarchy manipulation returns data that is used for the value of the operand. Each operand may finally be specified by a variable that has been previously created, or as a static value of a given data type.

The operator that relates the two operands together is selected by a dropdown box 916. The operator may be one of: equals, does not equal, greater than, greater than or equal, less than, less than or equal, begins with, does not begin with, ends with, does not end with, contains, and does not contain, among other types of operators. As can be appreciated by those of ordinary skill within the art, some types of operands are particular to some types of operators, such that in some embodiments, just the applicable operators are presented within the dropdown box 916 depending on the type of the operators. For example, it may not make sense for a numerical data type to be evaluated using a begins with, ends with, does not begin with, does not end with, contains, or does not contain operator, such that these operators may not be presented within the dropdown box 916 where the operators in question are of a numerical data type.

Referring back to FIG. 2C, once the user has manipulated the attributes, the dynamic attributes, and/or the operations of selected objects as desired, and/or has created logic constructs and/or loop constructs as desired, the host is ultimately manipulated based thereon (242). That is, parts 208, 216, 226, 230, and 236 are repeated as desired by the user, until what results is the desired manipulation of the host. To actually manipulate the host, one or more of the following can be performed, as has been already described in relation to FIG. 1.

First, an API may be provided by which the host can be directly manipulated (244). Second, at least some of the objects that have been selected may be converted to a text-based computer programming language that is directly understandable by the host (246). Third, at least some of the objects that have been selected may be converted to an intermediary text-based representation that is convertible to a computer programming language understandable by the host (248).

The embodiments that have been described herein can be extended and employed in other scenarios and situations than those particularly noted herein. For instance, some hosts may not expose objects that have attributes and operations. Rather, such hosts may simply just expose a list of attributes and/or a list of operations, or methods. Implicitly, such hosts may be considered as exposing a single object with attributes and operations, although the hosts may not call or define this exposure as such. However, the embodiments of the invention that have been described herein in relation to manipulating attributes and/or operations of navigable objects are amenable to this type of host as well. That is, the embodiments that have been described in particular in relation to manipulating attributes and/or operations can be used by themselves in relation to hosts that expose only attributes and/or operations, and not necessarily objects that are navigable. For example, parts 216, 226, 230, and 242, as well as their constituent parts, of the method 200 that have been described can be employed in relation to a host that exposes attributes and/or operations, but does not explicitly expose one or more objects.

Therefore, it is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof

I claim:

1. A method comprising:
accessing an interface of a host to receive a list of hierarchically organized objects that the host supports, each object having one or more attributes supported thereby and/or one or more operations supported thereby;
providing a graphical user interface (GUI) by which a user is to navigate a plurality of the objects to select one or more desired objects;
providing a GUI by which the user is to manipulate the attributes and/or the operations of the objects selected; and,
manipulating the host based at least on the objects selected as to which the attributes and/or the operations thereof have been manipulated.

2. The method of claim 1, wherein the host is one of a computer system and a computer program.

3. The method of claim 1, wherein accessing the interface of the host comprises one or more of:
retrieving for each attribute of each object having one or more attributes a data type of the attribute and whether the attribute is read-only or read-write; and,
retrieving for each operation of each object having one or more operations one or more parameters of the operation, a data type of each parameter, and whether each parameter is optional or required.

4. The method of claim 1, wherein providing the GUI by which the user is to navigate the plurality of objects to select the desired objects comprises:
providing a GUI by which the user is to select the desired objects; and,
graphically displaying each object selected as a path of objects including the object and each of one or more additional objects from which the object depends, in order of dependence.

5. The method of claim 4, wherein providing the GUI by which the user is to select the desired objects comprises providing a search box by which the user narrows down a list of objects from which the desired objects are selected based on one or more of names of the objects and descriptions of the objects.

6. The method of claim 4, wherein providing the GUI by which the user is to select the desired objects comprises organizing a list of objects from which the desired objects are selected into a plurality of categories, such that the user first selects a category and then selects one or more of the desired objects from the category selected.

7. The method of claim 1, wherein providing the GUI by which the user is to navigate the plurality of objects to select the desired objects comprises:
repeatingly providing a GUI by which the user is to select an object depending from a current object until a desired object has been selected; and,
graphically displaying the desired object selected as a path of objects including at least the desired object.

8. The method of claim 1, wherein providing the GUI by which the user is to manipulate the attributes and/or the operations of the objects selected comprises:
providing a GUI by which the user is to select a desired attribute or operation; and,
where a desired attribute has been selected,
where the desired attribute is read-only, denoting that a value of the desired attribute is to be retrieved based on a data type of the desired attribute;
where the desired attribute is read-write, providing a GUI by which the user is able to manipulate the desired attribute and based on the data type of the desired attribute.

9. The method of claim 1, wherein providing the GUI by which the user is to manipulate the attributes and/or the operations of the objects selected comprises:
providing a GUI by which the user is to select a desired attribute or operation; and,
where a desired operation has been selected,
for each parameter of one or more parameters of the desired operation, providing a GUI by which the user is able to manipulate the parameter and based on a data type of the parameter.

10. The method of claim 1, wherein manipulating the host comprises providing an interface by which the host is capable of being manipulated based at least on the objects selected as to which the attributes and/or the operations thereof have been manipulated.

11. The method of claim 1, wherein manipulating the host comprises one or more of:
converting at least the objects selected as to which the attributes and/or the operations thereof have been manipulated to a text-based computer programming language understandable by the host; and,
converting at least the objects selected as to which the attributes and/or the operations thereof have been manipulated to an intermediary text-based representation that is within a computer programming language understandable by the host.

12. The method of claim 1, further comprising providing a GUI by which the user is to manipulate a dynamic attribute of a selected object, wherein the dynamic attribute returns the selected object or another object when the dynamic attribute is evaluated,
such that evaluation of the dynamic attribute is capable of returning a different object based on a current status of the selected object when the dynamic attribute is evaluated.

13. The method of claim 12, wherein providing the GUI by which the user is to manipulate the dynamic attribute of the selected object comprises providing a GUI in which each of one or more different types of objects capable of being returned by the dynamic attribute is listed and the attributes, the operations, and/or children objects of the type of object are listed, such that the user is to select an attribute, an operation, or a child object of one of the different types of objects capable of being returned by the dynamic attribute.

14. The method of claim 13, wherein where evaluation of the dynamic attribute returns an object not having the attribute, the operation, or the children selected by the user, alerting the user that the object returned is unexpected.

15. The method of claim 1, further comprising providing a GUI by which the user is to create one or more variables that are used when manipulating the host, such that the host is manipulated based at least on the objects selected and the variables created.

16. The method of claim 15, wherein providing the GUI by which the user is to create the variables comprises one or more of:
enabling the user to create a variable independently by specifying a variable name, a variable type, and a variable value; and,
enabling the user to create a variable while navigating the plurality of the objects to select the desired objects, such that the variable results from manipulating an attribute or an operation of a selected object.

17. The method of claim 15, wherein one or more of:
providing the GUI by which the user is to navigate the plurality of the objects further comprises presenting the user with the variables created as selectable by the user; and,
providing the GUI by which the user is to manipulate the attributes and/or the operations of the objects selected further comprises presenting the user with one or more the variables created as selectable by the user to manipulate the attributes and/or the operations of a selected object.

18. The method of claim 1, further comprising providing a GUI by which the user is to create one or more logic constructs and/or one or more loop constructs, such that the host is manipulated based at least on the objects selected and the logic constructs and/or the loop constructs created.

19. The method of claim 18, wherein providing the GUI by which the user is to create one or more logic constructs and/or one or more loop constructs comprises providing a GUI by which a user specifies whether a plurality of conditions within a logic construct or a loop construct are to be evaluated in one of an AND or OR manner, to later determine whether one or more actions are to be performed when evaluating the conditions.

20. The method of claim 18, wherein providing the GUI by which the user is to create one or more logic constructs and/or one or more loop constructs comprises providing a GUI by which the user specifies a condition within a logic construct or a loop construct as including a plurality of operands and an operator relating the operands together.

21. A method comprising:
accessing an interface of a host to receive one or more attributes supported thereby and/or one or more operations supported thereby;
providing a GUI by which the user is to manipulate the attributes and/or the operations of the host; and,
manipulating the host based at least on the attributes and/or the operations thereof as have been manipulated.

22. The method of claim 21, wherein the host is one of a computer system and a computer program.

23. The method of claim 21, wherein accessing the interface of the host comprises one or more of:
retrieving for each attribute a data type of the attribute and whether the attribute is read-only or read-write; and,
retrieving for each operation one or more parameters of the operation, a data type of each parameter, and whether each parameter is optional or required.

24. The method of claim 21, wherein providing the GUI by which the user is to manipulate the attributes and/or the operations of the host comprises:
providing a GUI by which the user is to select a desired attribute or operation; and,
where a desired attribute has been selected,
where the desired attribute is read-only, denoting that a value of the desired attribute is to be retrieved based on a data type of the desired attribute;
where the desired attribute is read-write, providing a GUI by which the user is able to manipulate the desired attribute and based on the data type of the desired attribute.

25. The method of claim 21, wherein providing the GUI by which the user is to manipulate the attributes and/or the operations of the host comprises:
providing a GUI by which the user is to select a desired attribute or operation; and,
where a desired operation has been selected,
for each parameter of one or more parameters of the desired operation, providing a GUI by which the user is able to manipulate the parameter and based on a data type of the parameter.

26. The method of claim 21, wherein manipulating the host comprises one or more of:
converting the attributes and/or the operations that have been manipulated to a text-based computer programming language understandable by the host; and,
converting the attributes and/or the operations that have been manipulated to an intermediary text-based representation that is within a computer programming language understandable by the host.

27. The method of claim 21, further comprising providing a GUI by which the user is to manipulate a dynamic attribute of the host.

28. The method of claim 21, further comprising providing a GUI by which the user is to create one or more variables that are used when manipulating the host.

29. The method of claim 28, wherein providing the GUI by which the user is to create the variables comprises enabling the user to create a variable independently by specifying a variable name, a variable type, and a variable value.

30. The method of claim 28, wherein providing the GUI by which the user is to manipulate the attributes and/or the operations of the host further comprises presenting the user with one or more the variables created as selectable by the user to manipulate the attributes and/or the operations of the host.

31. The method of claim 21, further comprising providing a GUI by which the user is to create one or more logic constructs and/or one or more loop constructs.

32. The method of claim 31, wherein providing the GUI by which the user is to create one or more logic constructs and/or one or more loop constructs comprises providing a GUI by which a user specifies whether a plurality of conditions within a logic construct or a loop construct are to be evaluated in one of an AND or OR manner, to later determine whether one or more actions are to be performed when evaluating the conditions.

33. The method of claim 31, wherein providing the GUI by which the user is to create one or more logic constructs and/or one or more loop constructs comprises providing a GUI by which the user specifies a condition within a logic construct or a loop construct as including a plurality of operands and an operator relating the operands together.
